(19) United States
(12) Patent Application Publication
(10) Pub. No.: US 2009/0053116 A1
(43) Pub. Date: Feb. 26, 2009

(54) Apparatus for the production of bio-charcoal & other products

(75) Inventor: Hiran Rodrigues de Souza, Sao Paulo (BR)

Correspondence Address: Hiran Rodrigues de Souza, Rua Kaoru Oda, 271 J. Peri-Peri, Sao Paulo, SP, 05541-060, BR

(73) Assignee: Ivane Rodrigues de Souza, Sao Paulo-SP (BR)

(21) Appl. No.: 12/216,761

(22) Filed: Jul. 10, 2008

(30) Foreign Application Priority Data
Jul. 11, 2007 (BR) MU8701289-8

(51) Int. Cl. B09B 3/00

(52) U.S. Cl. 422/184.1

(57) ABSTRACT

An apparatus that is constructed by means of mounting and installing said apparatus into a soil boring that is used to convert high moisture content carbonaceous feedstocks into bio-charcoal and other products. In this apparatus, the high moisture content carbonaceous feedstocks are submitted to high hydrostatic pressure first in a column of water within the apparatus. Energy in the form of heat is then applied for heating and conversion. A large part of the heat furnished for the heating is derived from the exchange of heat between the high moisture feedstock and the converted bio-charcoal that can be collected to the outside temperature. Depending upon of the height of the water column, the conversion of the material may be accomplished by the generation of its own heat.

### (A) CROSS REFERENCES TO RELATED APPLICATIONS

See attached Information Disclosure Statements

### (B) STATEMENT REGARDING FEDERALLY SPONSORED RESEARCH OR DEVELOPMENT

Unknown

### (C) NAMES OF PARTIES TO A JOINT RESEARCH AGREEMENT

Pending

### (D) INCORPORATION-BY-REFERENCE OF MATERIAL SUBMITTED ON A COMPACT DISC

Not Applicable

### (E) BACKGROUND OF THE INVENTION

1. Field of the Invention

This invention relates to an apparatus to produce bio-charcoal and other products/processes from high moisture content carbonaceous feedstock.

2. Description of Related Art

Since early times, several processes have been known to thermochemically convert high moisture content carbonaceous feedstock to a useful form of energy. High moisture carbonaceous feedstock continue to be underutilized because of the high cost and amount of energy associated with drying the feedstocks and the technical problems associated with preparing the feedstocks so they can be fed to conventional thermochemical conversion systems. In the case of wet carbonization, the subject of the apparatus of this patent, it is not necessary for the initial drying process because the material is processed in the form of pulp diluted in water with solids between 3% and 80% percent. For this process one reactor is needed where the pulp is heated to a temperature between 150 and 400 degrees Celsius for a period of 5 to 60 minutes and pressure between ½ and 20 MPa, depending on the level of the desired carbonization. Instead of drying, the feedstock material is de-watered in the apparatus.

With grass a 1-L autoclave reactor is used in a laboratory with a period of 15 minutes and temperature of 260 degrees, and solids in pulp of 20%, the material will yield 60% bio-charcoal with 56% volatile matter. Under these conditions, the reactor reached a pressure of 4,8 MPa.

The results of the above mentioned experiment showed that this process with median temperatures and high pressures retained a large part of the volatile matter in the feedstock. The results of this experiment also included high yields of energy and mass and also yielded a fuel with a high heating value and high reactivity. The energy yield can reach a value of 80% of initial feedstock energy. The typical charcoal reaches an energy yield of 50%.

The physical and chemical properties of the product depend on the temperature. Increasing the temperature of the process increases the friability of the product and decreases the hygroscopic property of the product. For each temperature and time of the process, different properties can be produced with high precision. The energetic density and the carbon increase with the increase of temperature and time. The mass yield decreases with the increase of temperature, and the heating value increases.

The bio-carbon and other products/processes produced are easily de-watered by mechanical methods without the necessity of the drying process. The bio-carbon can be introduced into a boiler furnace, blast furnace, cement furnace and/or a ceramic furnace. The bio-carbon can also be mixed with liquid nutrients and utilized in the generation/regeneration of plantstocks of all types. Bricketts can also be manufactured from the products which are highly resistant to humidity since they have hygroscopic properties.

In general, for all types of feedstock, especially for the residual types, the process itself verifies the standard characteristics of the product. This fact makes the use of the high moisture feedstock viable as fuel. However, the handling, storage and transportation of the product are difficult and therefore present an obstacle for the viability of the product.

In spite of the attractions, the process presents other serious inconveniences such as the employment of the autoclave, which, for reasons of safety, cannot be used on a viable scale and consequently cannot yield the desired productivity.

In view of the above, and with the purpose of overcoming all of the above mentioned obstacles and problems, a new apparatus has been constructed which is the subject of this invention. This equipment permits the increase of a viable scale of production with high capacity of production and with total insurance of safety and efficiency.

### (F) SUMMARY OF THE INVENTION

An apparatus that is constructed by means of mounting and installing said apparatus into a soil boring that is used to convert high moisture content carbonaceous feedstocks into bio-charcoal, bio-carbon, bio-oil, sewage treatment, liquification of sludge and biomass gasification to ultimately produce gasses rich in methane or hydrogen and other products depending on the temperature and pressure of the process. In this apparatus, the high moisture content carbonaceous feedstocks are submitted to high hydrostatic pressure first in a column of water within the apparatus, then, energy in the form of heat is applied for heating and conversion. A large part of the heat furnished for the heating is derived from the exchange of heat between the high moisture feedstock and the converted bio-charcoal which can be collected at the temperature of the outside air. Depending upon of the height of the water column, the conversion of the material may be accomplished by the generation of its own heat.

### (G) BRIEF DESCRIPTION OF THE DRAWINGS

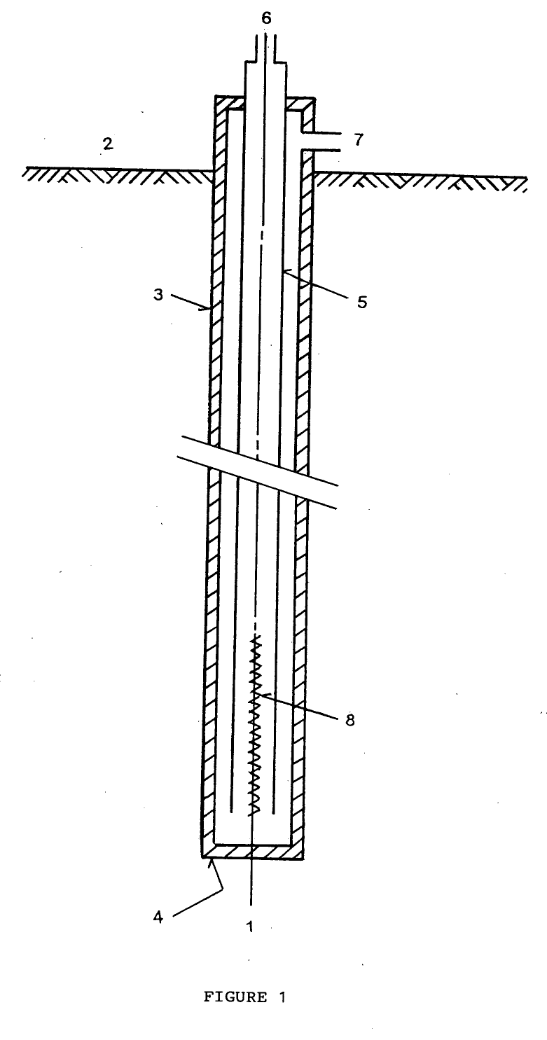

The design of FIG. 1 shows a cross section of the apparatus in the utilized process.

### (H) DETAILED DESCRIPTION OF THE INVENTION

The apparatus that facilitates the process, the object of this patent, consists of the components of vertical hole 1 in soil 2, with a depth of between 300 and 2000 meters, which corresponds with the desired carbonization rate. In pipe 3, which is introduced in vertical hole 1 with the extremity down, which lies on the bottom of hole 1 and is capped at depth 4, is constructed with a thermally insulated material resistant to corrosion and the pressure of the water column. Pipe 5, which is smaller in diameter than pipe 3, is introduced into pipe 3 and does not touch bottom 4. Pipe 5 is constructed of thin metal sheet, and is resistant to corrosion. Opening 6, which is at the extreme top of pipe 5, is where the feedstock in the form of pulp is diluted in water at the outside air temperature. The pulp is introduced or removed here. In opening 7, which is located at the extreme top of pipe 3, is also where the pulp can be introduced or removed. Heating system 8, which is at the extreme bottom of the equipment, could be electrical resistance heat or could be another type of heating system.

The processed pulp, which has the carbonized material, could be removed as previously indicated at opening 6 or opening 7, respectively with the hole that the pulp was initially introduced, to arrive at the desired humidity. Part of the water fraction resulting from the de-watering could be recycled, which then becomes available to the process to form the initial pulp and the remainder is utilized for other applications.

The process of carbonization previously mentioned becomes viable technically and economically through the utilization of millions of tons of materials that are wasted every year such as initial deforestation residuals, lumber production residuals, residuals from agricultural harvesting, residuals from agricultural refinery factories, sewage sludge, and any other industrial and/or municipal biomass residuals. The process also gives viability for the production of carbon which in turn will be mixed and used in the formation of soil rich in carbon for the generation/re-generation of plantstocks of all types: This process is facilitated by the absorption of the carbon in the atmosphere by plant stocks and ultimately through the utilization of biomass. Depending upon the catalysts and temperature utilized, the apparatus may be utilized for the manufacture of a variety of products/processes including bio-oil, sewage treatment, liquefaction of sludge and biomass gasification, to ultimately produce gasses rich in methane or hydrogen. In these cases the reactions are realized in high pressure and consequently in high depths in the hole.

What is claimed is:

1. An apparatus to produce bio-charcoal, bio-carbon, bio-oil, liquification of sludge and biomass gasification to ultimately produce gasses rich in methane or hydrogen, sewage and recyclables treatment, bio-carbon admixtures to be introduced into the soil for the generation/re-generation of plantstocks of all types including plantstocks capable of removing carbon from the atmosphere, and other products and processes depending on the temperature and pressure of the process, comprised of the components of vertical hole 1 in soil 2, with a depth of between 300 and 2000 meters, the depth of which corresponds to the desired carbonization rate. In pipe 3, which is introduced in vertical hole 1 with the extremity down, which lies on the bottom of hole 1 and is capped at depth 4, is constructed with a thermally insulated material resistant to corrosion and the pressure of the water column. Pipe 5, which is smaller in diameter them pipe 3, is introduced into pipe 3 and does not touch bottom 4 and is built with thin metal sheet that is resistant to corrosion. Opening 6, which is at the extreme top of pipe 5. Opening 7 is located at the extreme of top of pipe 3 and heating system 8 is at the extreme bottom of the equipment.

2. The apparatus to produce bio-charcoal and others products/processes of claim 1, wherein the operation of the apparatus is characterized by the introduction of feedstock in opening 6 or opening 7 in the form of diluted pulp in water at the outside temperature, and taking out the processed pulp in opening 7 or opening 6, depending upon where the feedstock was introduced.

3. The apparatus to produce bio-charcoal and others products/processes of claim 1, wherein the operation of the apparatus is characterized by heating the pulp at the bottom of pipe 3 or pipe 5 where the temperature is between 150-400 C., using the resistance heat 8 or another type of heating system for a period of 5-60 minutes.

4. The apparatus to produce bio-charcoal and others products/processes of claim 1, characterized by the fact that the pulp that is permitted to descend tube 3 or 5 and the pulp that rises through tube 5 or 3, respectively, exchanges the heat between the pulp that is ascending to the pulp that is descending through the fine metal pipe of tube 5 which results in the transfer of heat of the processed material which rises to the material that is descending that is not yet heated.

4. The apparatus to produce bio-charcoal and others products/processes of claim 1, characterized by the fact that tube 3 and bottom 4 are constructed with thermally isolating material which makes it difficult to transfer the heat of the inside of the apparatus to the exterior medium, resulting in the better utilization of the energy involved in the process.

5. The apparatus to produce bio-charcoal and others products/processes of claim 1, is characterized by the fact that the pulp can be processed by automatic heat transfer from the internal heat of the rising pulp to that of the descending pulp at some depth within the apparatus.

6. The apparatus to produce bio-charcoal and others products/processes of claim 1, is characterized by the fact that the bio-charcoal will contain more or less volatile matter depending on the depth of the apparatus.

7. The apparatus to produce bio-charcoal and others products/processes of claim 1, is characterized by the fact that if the apparatus produces a fraction of material that is not completely de-watered during the production of bio-charcoal, the unprocessed residual material may be recycled, in whole or in part, and re-utilized for the formation of the initial pulp.
